(19) United States
(12) Patent Application Publication
(10) Pub. No.: US 2012/0320841 A1
(43) Pub. Date: Dec. 20, 2012

(54) RADIO BASE STATION APPARATUS, MOBILE TERMINAL APPARATUS AND RADIO COMMUNICATION METHOD

(75) Inventors: Nobuhiko Miki, Tokyo (JP); Hidekazu Taoka, Tokyo (JP)

(73) Assignee: NTT DOCOMO, INC., Tokyo (JP)

(21) Appl. No.: 13/520,443

(22) PCT Filed: Jan. 13, 2011
(86) PCT No.: PCT/JP2011/050408

§ 371 Date: Aug. 22, 2012

(30) Foreign Application Priority Data
Jan. 18, 2010 (JP) 2010-008139

(51) Int. Cl. H04W 72/04

(52) U.S. Cl. 370/329; 370/328

(57) ABSTRACT

The present invention provides a radio base station apparatus, a radio terminal apparatus and a radio communication method that can realize highly efficient fallback mode when transmission diversity is adopted in fallback mode in an LTE-A system. With the radio communication method of the present invention, a radio base station apparatus, in fall back mode, performs scheduling for fallback mode, which takes into account the reference signal structures in fallback mode, and transmits a transmission signal after the scheduling by open loop control transmission diversity, and a mobile terminal apparatus receives a downlink signal including mode information, and, in fallback mode, performs channel estimation for fallback mode based on the mode information, and demodulates the downlink signal using the acquired channel estimation value.

### TECHNICAL FIELD

The present invention relates to a radio base station apparatus, mobile terminal apparatus and radio communication method to be used in a next-generation mobile communication system.

BACKGROUND ART

The LTE (Long Term Evolution) system (non-patent literature 1) defined by 3GPP (3rd Generation Partnership Project) employs MIMO (Multiple Input Multiple Output), which uses a plurality of transmission/reception antennas in a radio base station apparatus, to realize higher speed transmissions. Using this MIMO transmission, it is possible to perform scheduling in the space domain, in addition to scheduling in the time domain frequency domain.

Also, transmission diversity is a technique to use a plurality of antennas. These techniques are suitable to achieve a good coverage. Transmission diversity includes open loop control transmission diversity, which does not rely on feedback from a mobile terminal apparatus, and closed loop control transmission diversity (beam forming), which forms beams according to the channel state, based on feedback from a mobile terminal apparatus.

In the beam forming of closed loop control, an adequate weight (precoding matrix) is selected from a combination of antenna weights (codebook) that is prepared in advance, and transmission data is multiplied by the weight. In multi-layer transmission in the LTE system, precoding is performed based on the codebook per layer (stream), and transmission is performed using multiple streams. In this case, a precoding matrix that is selected is reported to a mobile terminal apparatus by a downlink control channel (Physical Downlink Control Channel: PDCCH).

In the LTE system, common reference signals (common RSs) are defined on a per antenna basis, and are transmitted individually from a downlink shared data channel (Physical Downlink Shared Channel: PDSCH). These common RSs are reference signals to be used in a mobile terminal apparatus to measure channel quality and to perform demodulation.

Consequently, in the event precoding is performed by the PDSCH (multiple-stream transmission mode), a mobile terminal apparatus demodulates a downlink shared data channel signal using precoding matrix information reported by the PDCCH and common RSs.

On the other hand, open loop control transmission diversity is used when, for example, closed loop control is unable to follow a fast-moving environment and needs to cope with rapid deterioration of reception quality and so on. In the LTE system, to perform MIMO transmission, fallback mode (space multiplexing of closed loop control of RANK=1) to transmit only one stream, is supported, to cope with rapid deterioration of reception quality and so on. Open loop control transmission diversity is applied upon this fallback mode as a very robust transmission method.

When transmission diversity is adopted in the PDSCH (fallback mode), a downlink shared data channel signal is demodulated by encoding a PDSCH signal by predetermined space coding (for example, by space frequency block code) and by performing decoding processing in a mobile terminal apparatus.

### CITATION LIST

### Non-Patent Literature

[Non-Patent Literature 1] 3GPP, TR25.912 (V7.1.0), “Feasibility study for Evolved UTRA and UTRAN,” September 2006

### SUMMARY OF INVENTION

### Technical Problem

In 3GPP, an LTE-A (LTE-Advanced) system is under investigation to realize high speed transmission in a wider coverage than the LTE system. In this LTE-A system, too, fallback mode is required to support the situation where, for example, closed loop control is unable to follow a fast-moving environment and needs to cope with rapid deterioration of reception quality and so on.

On the other hand, in the LTE-A system, in addition to common RSs, two types of reference signals (namely, the demodulation reference signals (DM-RSs) and channel quality measurement reference signals (CSI-RSs)) are defined on the downlink. In the LTE-A system, when precoding is applied to the PDSCH, demodulation processing is performed using DM-RSs that are multiplied by the same precoding matrix as that of the PDSCH, so that the common RSs are used only to measure channel quality. Consequently, the common RS of each antenna is limited only to part (for example, limited to the top OFDM (Orthogonal Frequency Division Multiplex) symbol).

In this way, if the common RS of each antenna is limited (that is, if the density of common RSs becomes lower), when open loop control transmission diversity is adopted in fallback mode, severe deterioration of reception quality is anticipated, and therefore highly efficient fallback mode cannot be realized.

The present invention has been made taking into account the above points, and it is therefore an object of the present invention to provide a radio base station apparatus, a mobile terminal apparatus and a radio communication method that can realize highly efficient fallback mode when transmission diversity is adopted in fallback mode in the LTE-A system.

### Solution to Problem

The radio base station apparatus of the present invention has: a precoding section that performs precoding for transmission data including a demodulation reference signal; a multiplexing section that multiplexes a common reference signal and the transmission data after the precoding; and a transmission section that transmits a transmission signal after the multiplexing, and, in fallback mode, the precoding section changes a precoding matrix per resource block of the transmission data.

The radio base station apparatus of the present invention has: a scheduling section that, in fallback mode, performs scheduling for fallback mode, which takes into account a reference signal structure in fallback mode; and a transmission section that transmits the transmission signal after the scheduling by transmission diversity with open loop control.

### Technical Advantages of Invention

With the radio base station apparatus of the present invention, in fallback mode, a precoding matrix is changed per resource block of transmission data, or, in fallback mode, scheduling for fallback mode, which takes into account the reference signal structures for fallback mode, is performed, so that, in an LTE-A system, it is possible to realize highly efficient fallback mode when transmission diversity is adopted in fallback mode.

### BRIEF DESCRIPTION OF DRAWINGS

FIGS. 1(a) to (c) are diagrams for explaining closed loop control transmission diversity in a radio base station apparatus according to the present invention;

FIG. 2 is a diagram for explaining reference signal structures in an LTE-A system;

FIGS. 3(a) and (b) are diagrams for explaining reference signal structures upon open loop control transmission diversity in a radio base station apparatus according to the present invention;

FIG. 4 is a diagram for explaining a configuration of a mobile communication system according to an embodiment of the present invention;

FIG. 5 is a block diagram showing an overall configuration of a radio base station apparatus in the mobile communication system shown in FIG. 4;

FIG. 6 is a functional block diagram of a baseband signal processing section according to embodiment 1 of the radio base station apparatus shown in FIG. 5;

FIG. 7 is a block diagram showing an overall configuration of a mobile terminal apparatus in the mobile communication system shown in FIG. 4;

FIG. 8 is a functional block diagram of a baseband signal processing section according to embodiment 2 of the radio base station apparatus shown in FIG. 5; and

FIG. 9 is a functional block diagram of a baseband signal processing section according to embodiment 2 of the mobile terminal apparatus shown in FIG. 7.

### DESCRIPTION OF EMBODIMENTS

Now, embodiments of the present invention will be described below in detail with reference to the accompanying drawings. The present invention proposes two methods to realize highly efficient fallback mode to cope with the situation where closed loop control is unable to follow a fast moving environment and needs to cope with rapid deterioration of reception quality and so on.

To begin with, the first method is a method to use precoding of rank 1 in fallback mode. In this case, precoding matrix is changed (switched) at predetermined intervals. Regarding the change of the precoding matrix at predetermined intervals according to the first method, the precoding matrix is changed regardless of feedback information (PMI: Precoding Matrix Indicator) from a mobile terminal apparatus, so that this means open loop control, not closed loop control. In this way, by changing the precoding matrix at predetermined intervals, directivity is smoothed even if beam forming is performed by precoding, so that it is possible to alleviate the disadvantage that characteristics depend on the location of a mobile terminal apparatus. The predetermined interval to change the precoding matrix is, for example, every resource block (RB) of transmission data.

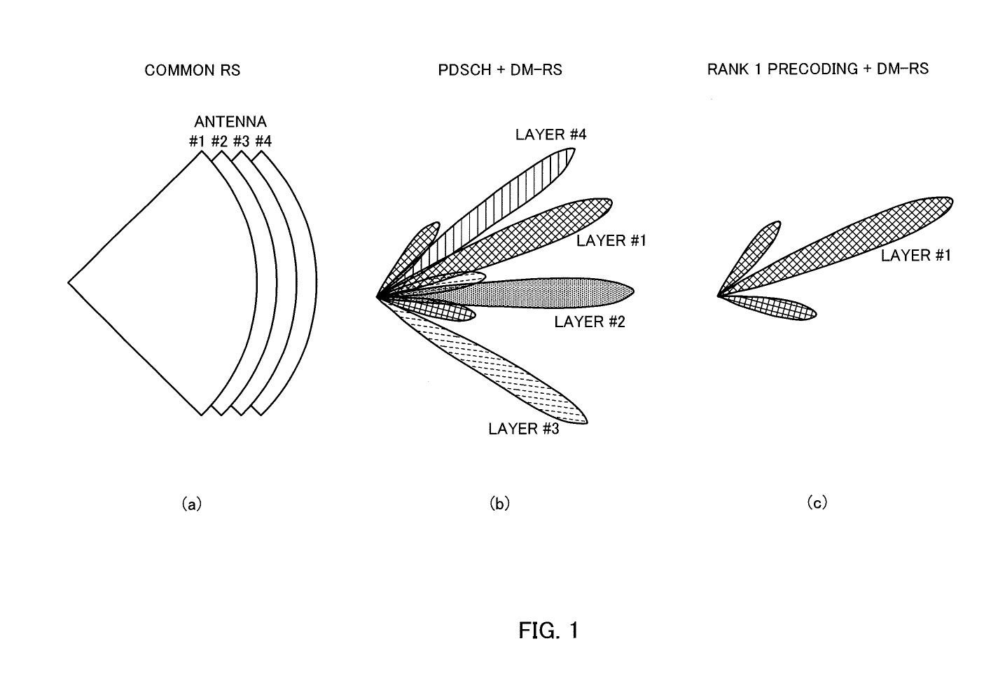

With the first method, based on mode information that identifies between multiple-stream transmission mode and fallback mode, closed loop control to perform precoding based on feedback information from a mobile terminal apparatus and open loop control to change the precoding matrix regardless of feedback information from a mobile terminal apparatus are switched. That is to say, with the first method, when mode information indicates multiple stream transmission mode, transmission data (PDSCH) and demodulation reference signals (DM-RSs) are subjected to beam forming as illustrated in FIG. 1(b), and transmitted in a state with directivity, and, when mode information indicates fallback mode, transmission data (PDSCH (space multiplexing)) and demodulation reference signals (DM-RSs) are subjected to beam forming as illustrated in FIG. 1(b), and, in a state with directivity, the transmission data and demodulation reference signals (DM-RSs) are transmitted by RANK 1 precoding, as illustrated in FIG. 1(c). At this time, the precoding matrix is changed at predetermined intervals. Note that the common RS of each antenna is transmitted in a non-directional (that is, omnidirectional) state, as illustrated in FIG. 1(a).

In the first method, in fallback mode, modulation is performed using demodulation reference signals (DM-RSs), so that a mobile terminal apparatus is able to employ the same structures as in multiple-stream transmission mode (space multiplexing).

With the second method, based on mode information that identifies between multiple stream transmission mode and fallback mode, closed loop control to perform precoding based on feedback information from a mobile terminal apparatus and open loop control transmission diversity (without beam forming) are switched. That is to say, with the second method, when mode information indicates multiple stream transmission mode, transmission data (PDSCH) and demodulation reference signals (DM-RSs) are subjected to beam forming as illustrated in FIG. 1(b), and transmitted in a state with directivity, and, when mode information indicates fallback mode, transmission data (PDSCH) is transmitted with open loop control transmission diversity. At this time, as described above, there are subframes in which the density of placement with respect to common RSs is low, so that it is necessary to take into account the reference signal structures.

Regarding the reference signal structures for fallback mode, it is preferable to use the reference signal structures that are employed in the LTE-A system or the reference signal structures that are employed in the LTE system, so that proposal is made here based on these reference signal structures.

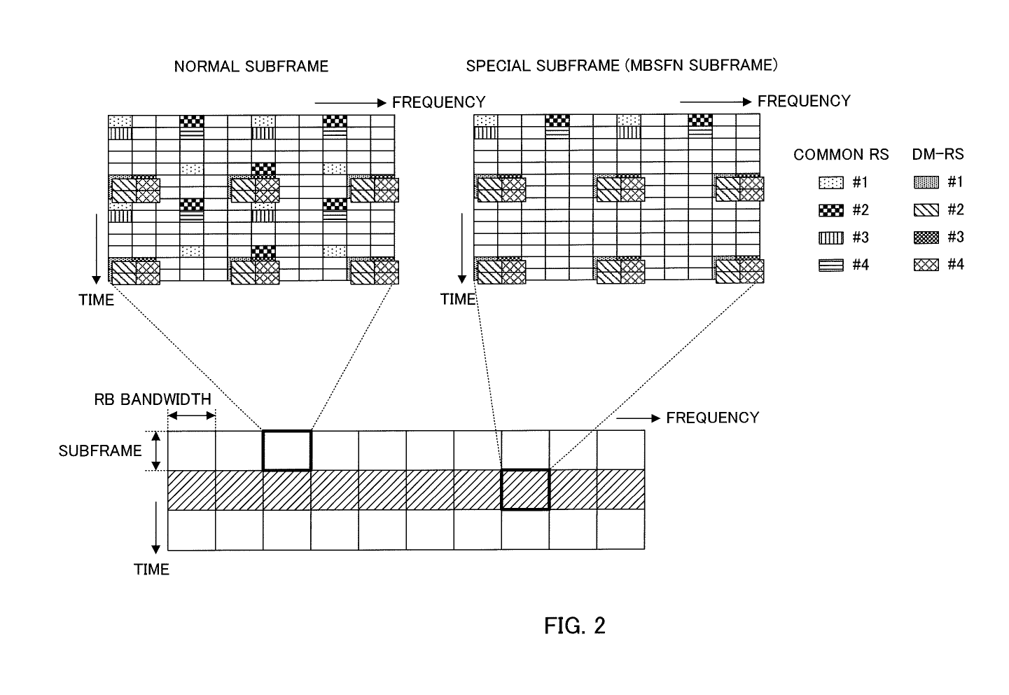

First, the reference signal structures employed in LTE-A will be described. FIG. 2 is a diagram illustrating the reference signal structures in the LTE-A system. These reference signal structures include the reference signal structure for normal subframes and the reference signal structure for special subframes (MBSFN (MBMS (Multimedia Broadcast and Multicast Service) over a Single Frequency Network) subframe).

The normal subframe reference signal structure is, as illustrated in FIG. 2 (the left structure in FIG. 2), a reference signal structure in which common RSs that are defined by the LTE system (Release-8) and demodulation reference signals (DM-RSs) that are defined by the LTE-A system are multiplexed. This reference signal structure is a structure in which DM-RSs are multiplexed only upon RBs where mobile terminal apparatuses supporting the LTE-A system are multiplexed.

The special subframe reference signal structure is, as illustrated in FIG. 2 (the right structure in FIG. 2), the MBSFN subframe reference signal structure that is defined by the LTE system (Release-8). This reference signal structure is a structure in which common RSs are multiplexed only upon the first one OFDM symbol or two OFDM symbols. The density of common RSs is lowered because, although, in the LTE system (Release-8), common RSs are used for data demodulation in addition to data quality measurement, DM-RSs are defined newly in the LTE-A system, and common RSs are used only for limited purposes such as channel quality measurement.

The present invention takes into account these reference signal structures and proposes reference signal structures in fallback mode.

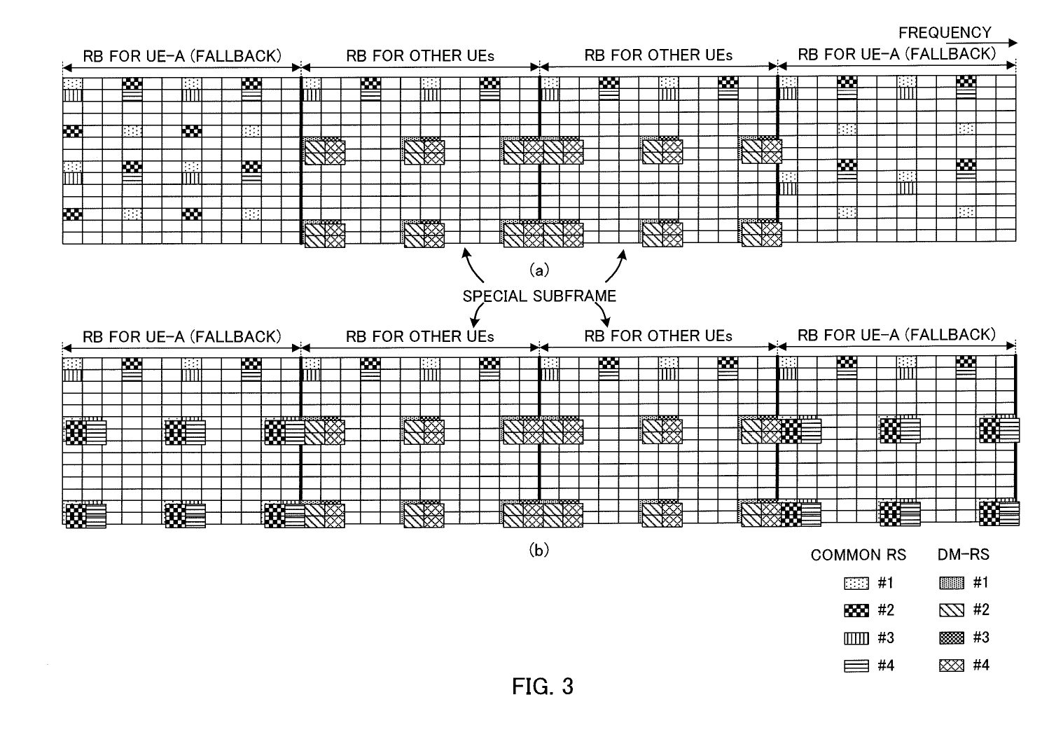

In the first example, as illustrated in FIG. 3(a), common reference signal structures that are defined in the LTE system (Release-8) are used. That is to say, the common reference signal structure defined in the LTE system (Release-8) is used for a mobile terminal apparatus (UE-A) in fallback mode, and the special subframe reference signal structure illustrated in FIG. 2 is used for other mobile terminal apparatuses (other UEs) in multiple-stream transmission mode. By adopting such reference signal structures, channel estimation can be performed in the same way as with normal subframes. Note that, as illustrated in FIG. 3(a), because common RSs are not placed in all RBs, it is preferable to change, for example, interpolation in the frequency domain as needed.

With the second example, as illustrated in FIG. 3(b), the same structure as for the demodulation reference signal in the LTE-A system is used. That is to say, for a mobile terminal apparatus (UE-A) in fallback mode, a structure in which common reference signals are placed instead of demodulation reference signals in the special subframe structure is used, and, for mobile terminal apparatuses (other UEs) in multiple-stream transmission mode, the special subframe reference signal structure illustrated in FIG. 2 is used. These reference signal structures are structures that are optimized as demodulation reference signal structures, so that the accuracy of channel estimation in a mobile terminal apparatus is higher than the first example. Also, in these reference signal structures, channel estimation can be used in the same way as for demodulation reference signals. However, in this case, it is necessary not to use the reference signal of the top OFDM symbol for channel estimation. Also, when using all reference signals for channel estimation, it is preferable to use channel estimation methods to match these.

### Embodiment 1

A case will be described here with the present embodiment where the precoding matrix is changed per resource block of transmission data.

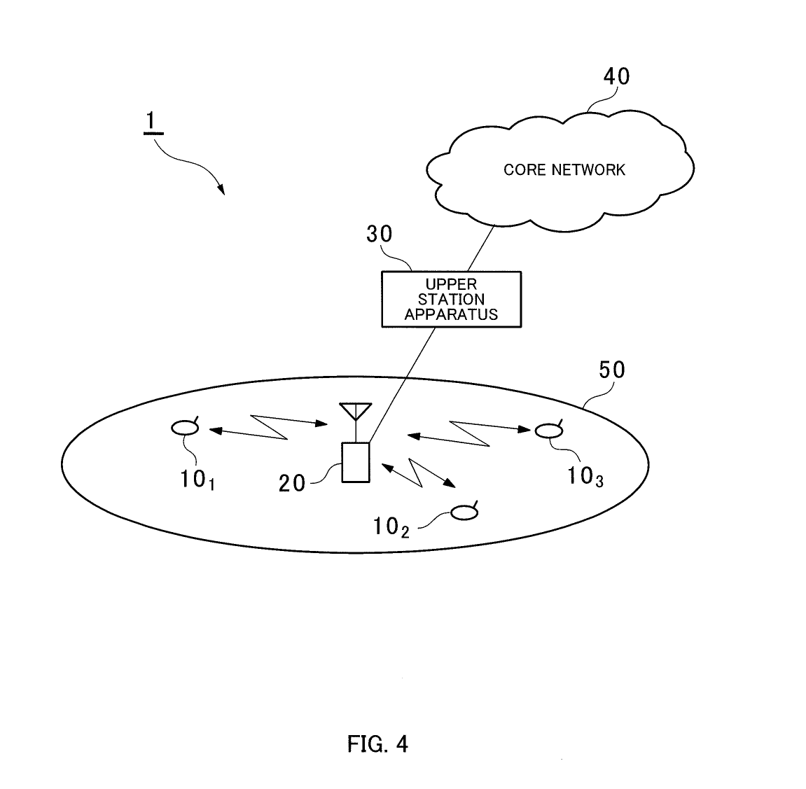

First, referring to FIG. 4, a mobile communication system 1 having a mobile terminal apparatus (UE) 10 and a radio base station apparatus (eNB) 20 according to an embodiment of the present invention will be described.

FIG. 4 is a diagram for explaining the configuration of a mobile communication system 1 having a mobile terminal apparatus 10 and a radio base station apparatus 20 according to an embodiment of the present invention. Note that the mobile communication system 1 illustrated in FIG. 4 is a system to incorporate, for example, the LTE system or SUPER 3G. Also, this mobile communication system 1 may be referred to as “IMT-Advanced system” or “4G system.”

As illustrated in FIG. 3, the mobile communication system 1 is configured to include the radio base station apparatus 20 and a plurality of mobile terminal apparatuses 10 (10₁, 10₂, 10₃, . . . 10ₙ, where n is an integer to satisfy n>0) that communicate with this radio base station apparatus 20. The radio base station apparatus 20 is connected with an upper station apparatus 30, and this upper station apparatus 30 is connected with a core network 40. The mobile terminal apparatuses 10 communicate with the radio base station apparatus 20 in a cell 50. Note that the upper station apparatus 30 includes, for example, an access gateway apparatus, a radio network controller (RNC), a mobility management entity (MME) and so on, but is by no means limited to these.

The mobile terminal apparatuses (10₁, 10₂, 10₃, . . . 10ₙ) have the same configuration, functions and state, so that, the following description will be given with respect to “mobile terminal apparatus 10,” unless specified otherwise. Also, although the mobile terminal apparatus 10 performs radio communication with the radio base station apparatus 20 for ease of explanation, more generally, user apparatuses (UE: User Equipment) including mobile terminal apparatuses and fixed terminal apparatuses may be used as well.

In the mobile communication system 1, as radio access schemes, OFDMA (Orthogonal Frequency Division Multiple Access) is applied to the downlink, and SC-FDMA (Single-Carrier Frequency-Division Multiple Access) is applied to the uplink. OFDMA is a multi-carrier transmission scheme of performing communication by dividing a frequency band into a plurality of narrow frequency bands (subcarriers) and mapping data to each subcarrier. SC-FDMA is a single carrier transmission scheme of reducing interference between mobile terminal apparatuses by dividing a system band into bands formed with one or continuous resource blocks, per terminal, and allowing a plurality of terminals to use mutually different bands.

Here, the communication channels in the LTE system will be described. On the downlink, a PDSCH that is used by each mobile terminal apparatus 10 on a shared basis, and downlink control channels (PDCCH, PCFICH and PHICH) are used. By means of this PDSCH, user data, that is, normal data signals, is transmitted. Transmission data is included in this user data. Note that the component carriers and scheduling information assigned to the mobile terminal apparatus 10 in the radio base station apparatus 20 are reported to the mobile terminal apparatus 10 by an L1/L2 control channel.

On the uplink, a PUSCH (Physical Uplink Shared Channel) that is used by each mobile terminal apparatus 10 on a shared basis and a PUCCH (Physical Uplink Control Channel) which is an uplink control channel are used. User data is transmitted by means of this PUSCH. Furthermore, by means of the PUCCH, downlink channel quality information (CQI: Channel Quality Indicator) and so on are transmitted.

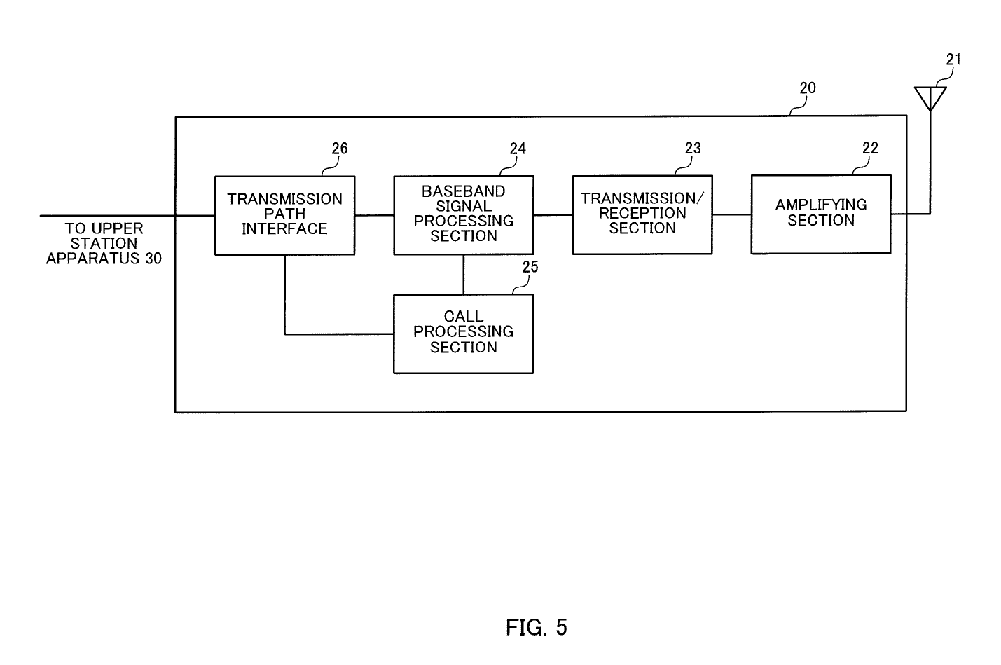

Now, referring to FIG. 5, an overall configuration of the radio base station apparatus 20 according to the present embodiment will be explained. The radio base station apparatus 20 has a transmission/reception antenna 21, an amplifying section 22, a transmission/reception section 23, a baseband signal processing section 24, a call processing section 25, and a transmission path interface 26. The transmission means is formed with these transmission/reception antenna 21, amplifying section 22, transmission/reception section 23 and baseband signal processing section 24.

User data that is transmitted on the downlink from the radio base station apparatus 20 to the mobile terminal apparatus 10 is input in the baseband signal processing section 24 through the transmission path interface 26, from the upper station apparatus 30, which is positioned above the radio base station apparatus 20.

In the baseband signal processing section 24, PDCP layer processing, RLC (Radio Link Control) layer transmission processing such as such as division and coupling of user data and RLC retransmission control transmission processing, MAC (Medium Access Control) retransmission control, including, for example, HARQ (Hybrid Automatic Repeat reQuest) transmission processing, scheduling, transport format selection, channel coding, inverse fast Fourier transform (IFFT) processing, and precoding processing, are performed. Furthermore, as with signals of the physical downlink control channel, which is a downlink control channel, transmission processing such as channel coding and inverse fast Fourier transform are performed, and the result is transferred to the transmission/reception section 23.

In the transmission/reception section 23, the baseband signal output from the baseband signal processing section 24 is converted into a radio frequency band through frequency conversion processing, and, after that, amplified in the amplifying section 22 and transmitted from the transmission/reception antenna 21.

On the other hand, as for the signals transmitted from the mobile terminal apparatus 10 to the radio base station apparatus 20 on the uplink, a radio frequency signal received in the transmission/reception antenna 21 is amplified in the amplifying section 22. Then, the radio frequency signal is converted into a baseband signal through frequency conversion in the transmission/reception section 23, and input in the baseband signal processing section 24.

The baseband signal processing section 24 performs FFT processing, IDFT processing, error correction decoding, MAC retransmission control reception processing, and RLC layer and PDCP layer reception processing for the user data included in the baseband signal that is received as input, and transfers the result to the upper station apparatus 30 through the transmission path interface 26.

The call processing section 25 performs call processing such as setting up and releasing a communication channel, manages the state of the base station apparatus 20 and manages the radio resources.

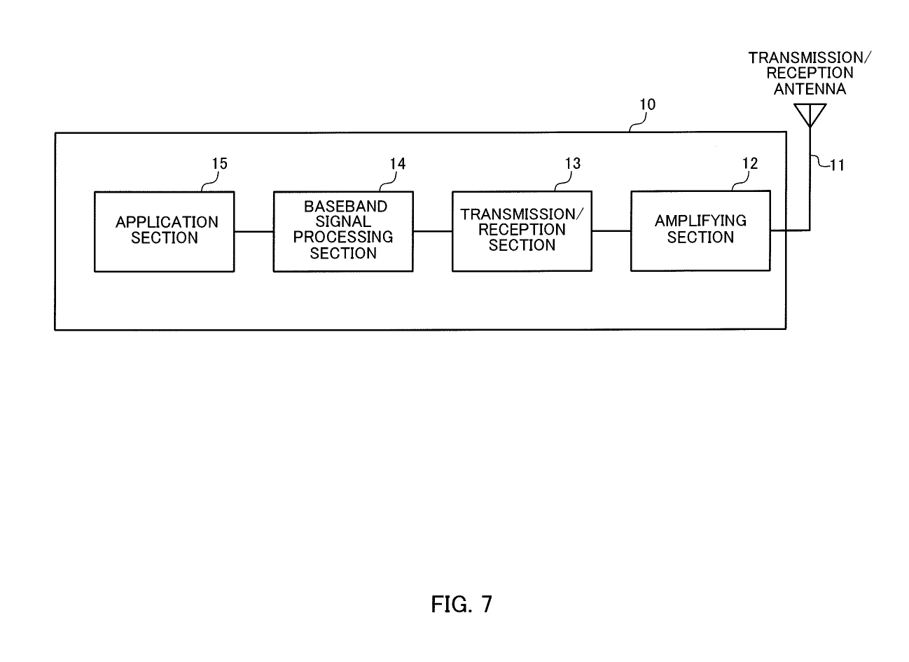

Next, an overall configuration of the mobile terminal apparatus 10 according to the present embodiment will be described with reference to FIG. 7. A mobile terminal apparatus to support the LTE system (LTE-supporting terminal) and a mobile terminal apparatus to support the LTE-A system (LTE-A-supporting terminal) have the same hardware principle part configurations, so that they will be described without distinguishing between them. The mobile terminal apparatus 10 has a transmission/reception antenna 11, an amplifying section 12, a transmission/reception section 13, a baseband signal processing section 14, and an application section 15. These transmission/reception antenna 11, amplifying section 12, transmission/reception section 13 and part of the baseband signal processing section 14 constitute the reception means.

When a signal is received, a radio frequency signal received in the transmission/reception antenna 11 is amplified in the amplifying section 12 and then converted into a baseband signal through frequency conversion in the transmission/reception section 13. This baseband signal is subjected to FFT processing, error correction decoding, retransmission control reception processing and so on in the baseband signal processing section 14. In this downlink data, downlink user data is transferred to the application section 15. The application section 15 performs processing related to upper layers above the physical layer and the MAC layer. Also, in the downlink data, broadcast information is also transferred to the application section 15.

On the other hand, upon transmission, uplink user data is input from the application section 15 to the baseband signal processing section 14. In the baseband signal processing section 14, retransmission control (HARQ (Hybrid ARQ)) transmission processing, channel coding, DFT processing, IFFT processing and so on are performed, and the result is transferred to the transmission/reception section 13. The baseband signal output from the baseband signal processing section 14 is subjected to frequency conversion processing in the transmission/reception section 13 and converted into a radio frequency band, and, after that, amplified in the amplifying section 12 and transmitted from the transmission/reception antenna 11.

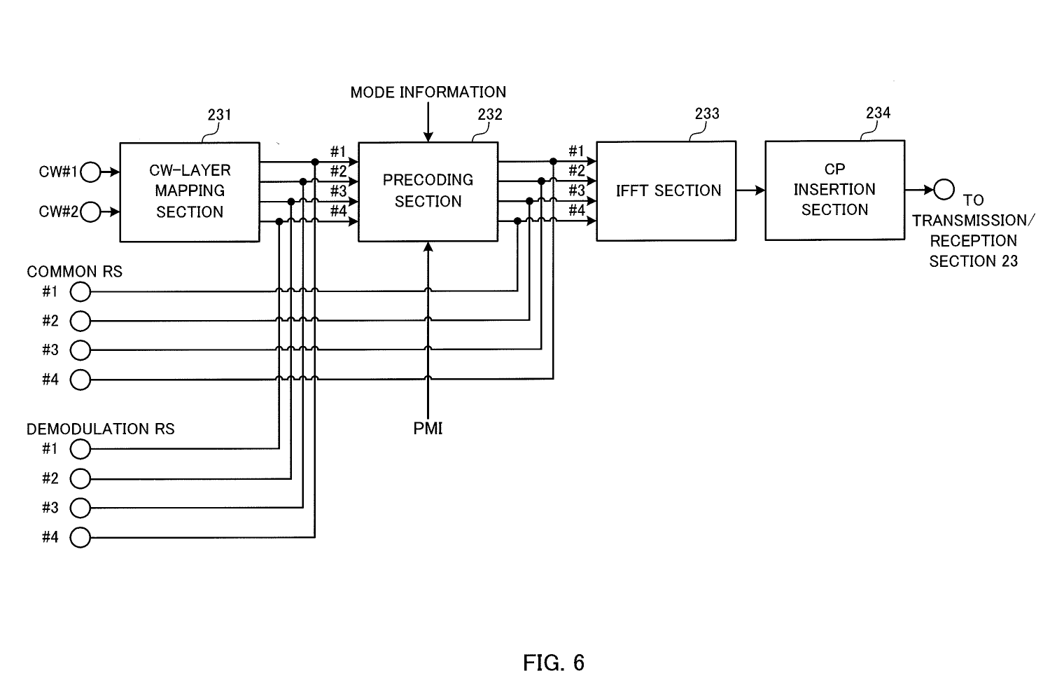

FIG. 6 is a functional block diagram of the baseband signal processing section 24 provided in the radio base station apparatus 20 according to embodiment 1 of the present invention, and primarily shows the function blocks of the transmission processing section in the baseband signal processing section 24.

The baseband signal processing section 24 is formed mainly with a CW-layer mapping section 231 that maps codewords (CW) to each layer, a precoding section 232 that pre-encodes the signals mapped to each layer and demodulation reference signals, an IFFT section 233 that performs an IFFT on the signals after precoding and common RSs, and CP insertion section 234 that inserts CPs (Cyclic Prefixes) in the signals after the IFFT.

The CW-layer mapping section 231 maps a codeword (CW), which is a group of input data to adaptive modulation to match the transport block, to each layer. The CW-layer mapping section 231 outputs the signals mapped to each layer to the precoding section 232.

As illustrated in FIG. 1(b), the precoding section 232 pre-encodes the signal mapped to each layer (PDSCH signals) and demodulation reference signals (DM-RSs). The precoding section 232 pre-encodes the PDSCH signals and DM-RSs using codebooks that are selected based on feedback information (PMI) from the mobile terminal apparatus. Note that the rank (the number of layers) and codebook are reported to the mobile terminal apparatus in subframe units.

Also, in fallback mode, as illustrated in FIG. 1(c), the precoding section 232 performs RANK=1 precoding for the PDSCH signal and DM-RS mapped to one layer (layer #1 in FIG. 1(c)). In this case, the precoding matrix is changed at predetermined intervals—for example, per PDSCH signal resource block. Note that, in this case, the rank (the number of layers) and codebook are not reported to the mobile terminal apparatus.

These two types of control identify between multiple stream transmission mode and fallback mode. That is to say, according to mode information, the precoding section 232 switches between closed loop control to perform precoding based on feedback information from the mobile terminal apparatus and open loop control to change the precoding matrix regardless of feedback information from the mobile terminal apparatus. Note that the mode information is reported to the mobile terminal apparatus by upper control information.

In multiple-stream transmission mode, the mobile terminal apparatus combines the reference signals (common RSs and DM-RSs) and the codebook and performs synchronization detection of downlink signals having been subjected to beam forming. On the other hand, in fallback mode, using reference signals (common RSs and DM-RSs), synchronization detection of downlink signals which have different beam shapes at predetermined intervals, is performed. These two types of control in the mobile terminal apparatus are switched based on mode information that is reported from the radio base station apparatus.

The precoding section 232 outputs a precoded signal to the IFFT section 233. Note that common RSs are multiplexed over a precoded signal. Consequently, a multiplex signal is output to the IFFT section 233. The IFFT section 233 converts the precoded signal into a time domain signal by performing an IFFT. The IFFT section 233 outputs the signal after the IFFT to the CP insertion section 234. The CP insertion section 234 inserts CPs into the signal after the IFFT. Transmission data in which CPs are inserted, is transmitted from the transmission/reception antenna 21 on the downlink (PDSCH), to each mobile terminal apparatus. That is to say, transmission data is transmitted by closed loop control transmission diversity (beam forming) in multiple-stream transmission mode and transmitted by RANK=1 precoding in fallback mode.

As described above, with the radio communication method according to the present embodiment, the radio base station apparatus precodes transmission data including demodulation reference signals, multiplexes common reference signals over transmission data after the precoding, and transmits a transmission signal after the multiplexing by closed loop control transmission diversity, and this method is characterized in that, in fallback mode, the precoding matrix is changed per resource block of the transmission data. With the present embodiment, in fallback mode, the precoding matrix is changed per resource block of transmission data, so that, in the LTE-A system, when transmission diversity is adopted in fallback mode, highly efficient fallback mode can be realized.

### Embodiment 2

A case will be described now with the present embodiment where, in fallback mode, scheduling for fallback mode, which takes into account the reference signal structures for fallback mode, is performed. Note that, in embodiment 2, the configuration of the mobile communication system 1, the overall configuration of the radio base station apparatus 20 and the overall configuration of the mobile terminal apparatus are the same as in embodiment 1, and so their detailed descriptions will be omitted.

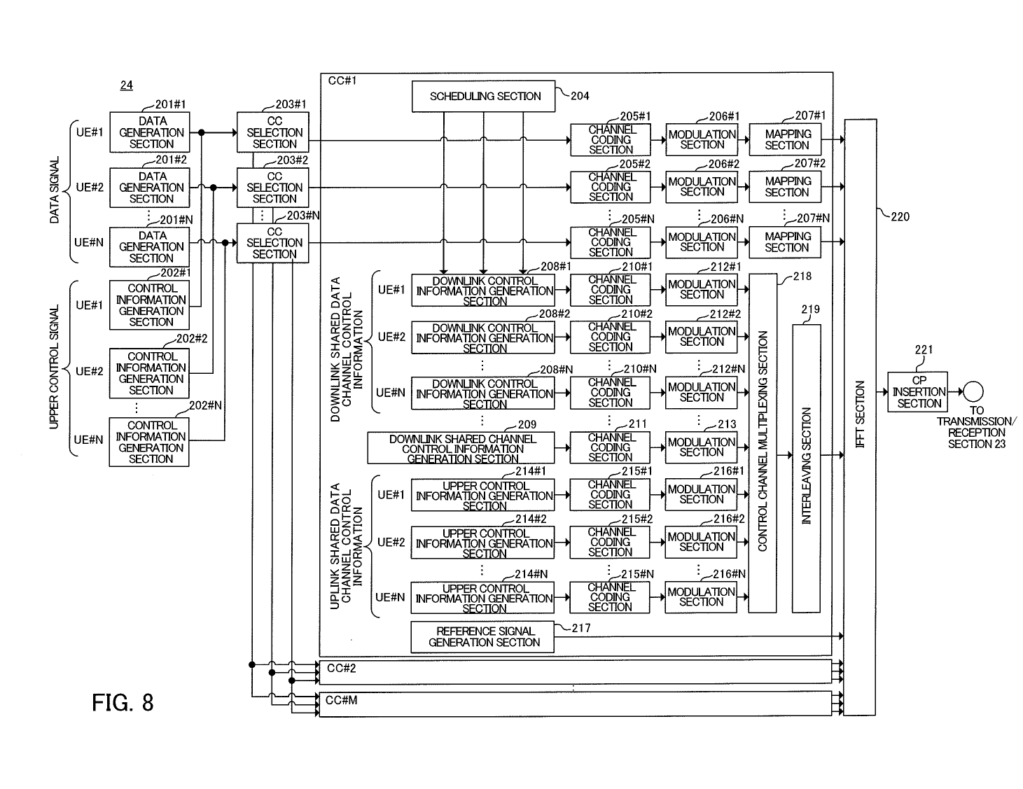

FIG. 8 is functional block diagram of a baseband signal processing section 24 provided in the radio base station apparatus 20 according to embodiment 2, and primarily shows the function blocks of the transmission processing section in the baseband signal processing section 24. Note that, with FIG. 8, the downlink configuration to transfer transmission data for the mobile terminal apparatus 10 under the radio base station apparatus 20 from the upper station apparatus 30 to the radio base station apparatus 20 will be described. Also, FIG. 8 illustrates a configuration of the radio base station apparatus 20 that supports the mobile communication system 1 where the number of component carriers is M (CC #1 to CC #M).

The data generation sections 201 #1 to 201 #N generate user data on a per user basis, from transmission data transferred from upper station apparatus 30. The control information generation sections 202 #1 to 202 #N generate, on a per user basis, upper control signals to report to the mobile terminal apparatus 10 by RRC signaling, which includes information related to the PDCCH and PDSCH described above. With the present embodiment, the control information generation sections 202 #1 to 202 #N generate, on a per user basis, upper control signals including mode information (which indicates multiple-stream transmission mode or fallback mode). The component carrier selection sections 203 #1 to 203 #N select, on a per user basis, component carriers to use in radio communication with the mobile terminal apparatus 10.

The scheduling section 204 controls resource allocation related to component carrier CC #1 and performs scheduling by distinguishing between the LTE-supporting terminal and the LTE-A-supporting terminal. The scheduling section 204 receives as input transmission data and retransmission command from the upper station apparatus 30, and also receives as input, from the reception section having received an uplink signal, the channel estimation values and the CQIs of the resource blocks. The scheduling section 204 schedules the uplink and downlink control signals and uplink and downlink shared channel signals with reference to the retransmission command input from the upper station apparatus 30, the channel estimation values and CQIs. A propagation path in mobile communication varies differently per frequency, due to frequency selective fading. So, upon transmission of user data to a user terminal, adaptive frequency scheduling to assign resource blocks of good communication quality to each user terminal on a per subframe basis is used. In adaptive frequency scheduling, for each resource block, a user terminal of good propagation path quality is selected and assigned. Consequently, the scheduling section 204 assigns resource blocks using the CQI of each resource block fed back from each user terminal. Also, the MCS (Coding Rate and modulation Scheme) that fulfills a required block error rate with the assigned resource blocks is determined.

Also, in fallback mode, the scheduling section 204 performs scheduling for fallback mode, which takes into account the reference signal structures. That is to say, in fallback mode, the scheduling section 204 performs scheduling based on, for example, the reference signal structures illustrated in FIGS. 3(a) and (b).

To be more specific, in the first example, as illustrated in FIG. 3(a), the scheduling section 204 uses the common reference signal structure defined by the LTE system (Release-8) with respect to a mobile terminal apparatus (UE-A) in fallback mode, and uses the special subframe reference signal structure illustrated in FIG. 2 for mobile terminal apparatuses (other UEs) in multiple-stream transmission mode, and therefore performs resource allocation based on such these reference signal structures.

Also, in the second example, as illustrated in FIG. 3(b), the scheduling section 204 uses a structure in which common reference signals are placed instead of the demodulation reference signals in the special subframe structure with respect to a mobile terminal apparatus (UE-A) in fallback mode, and uses the special subframe reference signal structure illustrated in FIG. 2 for mobile terminal apparatuses (other UEs) in multiple-stream transmission mode, and therefore performs resource allocation based on such these reference signal structures.

The baseband signal processing section 24 has channel coding sections 205 #1 to 205 #N that perform, on a per user basis, channel coding of the shared data channel (PDSCH) which transmits user data output from the data generation section 201 and control signals output from the control information generation section 202, modulation sections 206 #1 to 206 #N that modulate, on a per user basis, transmission data having been subjected to channel coding, and mapping sections 207 #1 to 207 #N that map the modulated transmission data to radio resources.

Furthermore, the baseband signal processing section 24 has downlink control information generation sections 208 #1 to 208 #N that generate downlink shared data channel control information, which is user-specific downlink control information, and a downlink shared channel control information generation section 209 that generates downlink shared control channel control information, which is downlink control information that is common between users. The downlink control information generation sections 208 #1 to 208 #N generate control signals to report to the mobile terminal apparatus 10 by the PDSCH, on a per user basis. The baseband signal processing section 24 has channel coding sections 210 #1 to 210 #N that perform, on a per user basis, channel coding of control information generated in the downlink control information generation sections 208 #1 to 208 #N, a channel coding section 211 that performs channel coding of downlink shared control channel control information generated in the downlink shared channel control information generation section 209, and modulation sections 206 #1 to 206 #N and 213 that modulate, on a per user basis, transmission data having been subjected to channel coding in the channel coding sections 210 and 211.

Furthermore, the baseband signal processing section 24 has uplink control information generation sections 214 #1 to 214 #N that generate, on a per user basis, uplink shared data channel control information, which is control information for controlling the uplink shared data channel (PUSCH), channel coding sections 215 #1 to 215 #N that perform, on a per user basis, channel coding of uplink shared data channel control information that is generated, and modulation sections 216 #1 to 216 #N that modulate, on a per user basis, uplink shared data channel control information having been subjected to channel coding. The uplink control information generation section 214 generates uplink shared data channel control information by distinguishing between the LTE-supporting terminal and the LTE-A-supporting terminal.

The reference signal generation section 217 generates reference signals such as common RSs, DM-RSs and CSI-RSs based on the reference signal structures. That is to say, the reference signal generation section 217 generates common RSs and DM-RSs based on the reference signal structures illustrated in FIG. 2 and FIGS. 3(a) and (b). The reference signal generation section 217 outputs the reference signals to the IFFT section 220.

Control information modulated on a per user basis in the above modulation sections 212 #1 to 212 #N, 213 and 216 #1 to 216 #N is multiplexed in the control channel multiplexing section 218 and furthermore interleaved in the interleaving section 219. Control signals output from the interleaving section 219 and transmission data output from the mapping sections 207 #1 to 207 #N are input in the IFFT section 220 as downlink channel signals. The IFFT section 220 performs an inverse fast Fourier transform on the downlink channel signals and converts the frequency domain signals into a time sequence signal. The CP insertion section 221 inserts CPs in the time sequence signal of downlink channel signals. Note that a CP functions as a guard interval for cancelling the differences in multipath propagation delay. Transmission data in which CPs are inserted is transmitted to the transmission/reception section 23 and transmitted by open loop control transmission diversity to the mobile terminal apparatus on the downlink. That is to say, in multiple-stream transmission mode, transmission data is transmitted in the special subframe reference signal structure illustrated in FIG. 2, and, in fallback mode, transmitted in the reference signal structure illustrated in FIG. 3(a) or 3(b).

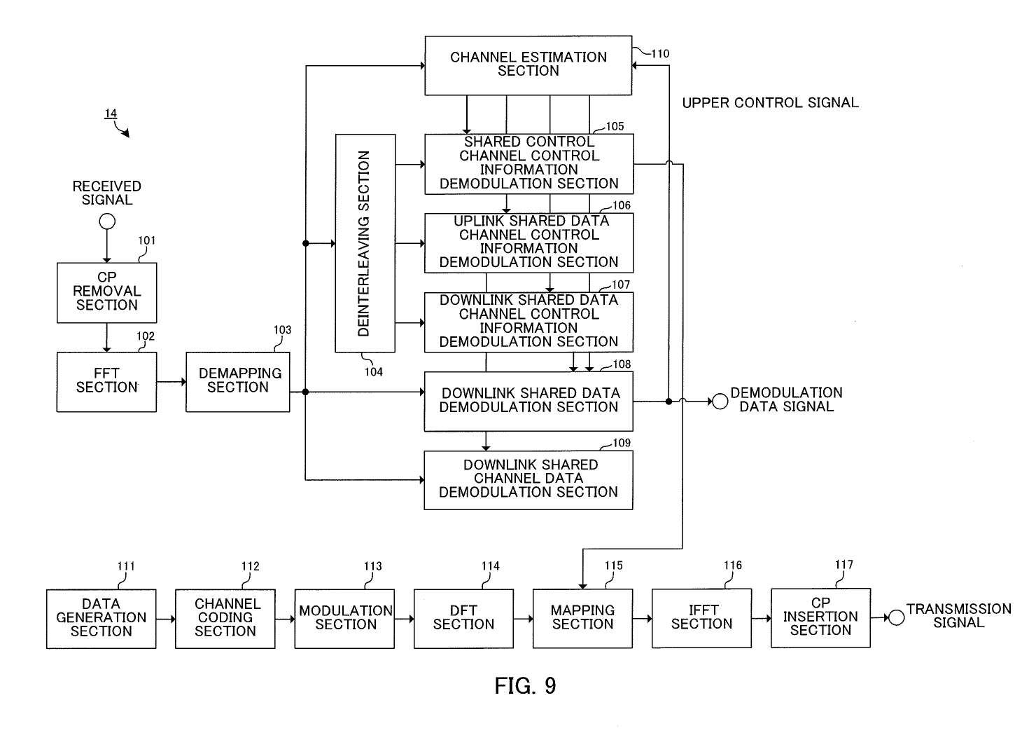

FIG. 9 is a functional block diagram of the baseband signal processing section 14 provided in the mobile terminal apparatus 10 according to embodiment 2, and primarily shows the function blocks of the transmission processing section in the baseband signal processing section 14. First, the downlink configuration of the mobile terminal apparatus 10 will be explained.

A downlink signal that is received as received data from the radio base station apparatus 20 has the CPs removed in the CP removal section 101. This downlink signal includes mode information which identifies multiple-stream transmission mode or fallback mode. The downlink signal, from which the CPs have been removed, is input in the FFT section 102. The FFT section 102 performs a fast Fourier transform (FFT) on the downlink signal, converts the time domain signal into a frequency domain signal and inputs this signal in the demapping sections 103. The demapping sections 103 demaps the downlink signal, and extracts, from the downlink signal, multiplex control information in which a plurality of pieces of control information are multiplexed, user data and upper control signals. Note that the demapping processing in the demapping sections 103 is performed based on the upper control signals input from the application section 15. The multiplex control information output from the demapping sections 103 is de-interleaved in the de-interleaving section 104.

Also, the baseband signal processing section 14 has a shared control channel control information demodulation section 105 that demodulates downlink shared control channel control information from multiplex control information, an uplink shared data channel control information demodulation section 106 that demodulates uplink shared data channel control information from multiplex control information, a downlink shared data channel control information demodulation section 107 that demodulates downlink shared data channel control information from multiplex control information, a downlink shared data modulation section 108 that demodulates user data and upper control signals, and a downlink shared channel data demodulation section 109 that demodulates downlink shared channel data.

The shared control channel control information demodulation section 105 extracts shared control channel control information, which is control information that is common between users, by performing the blind decoding processing, demodulation processing, channel decoding processing and so on of the common search space of multiplex control information (PDCCH). The shared control channel control information includes downlink channel quality information (CQI), input in a mapping section 115 (described later), and mapped as part of transmission data for the radio base station apparatus 20.

The uplink shared data channel control information demodulation section 106 extracts uplink shared data channel control information, which is user-specific uplink control information, by performing the blind decoding processing, demodulation processing, channel decoding processing and so on of the user-specific search space of multiplex control information (PDCCH). The uplink shared data channel control information is used to control the uplink shared data channel (PUSCH), and is input in the downlink shared channel data demodulation section 109.

The downlink shared data channel control information demodulation section 107 extracts downlink shared data channel control information, which is user-specific downlink control signals, by performing the blind decoding processing, demodulation processing, channel decoding processing and so on of the user-specific search space of multiplex control information (PDCCH). The downlink shared data channel control information is used to control the downlink shared data channel (PDSCH), and is input in the downlink shared channel data demodulation section 108.

Also, the downlink shared data channel control information demodulation section 107 performs blind decoding processing of the user-specific search space based on information about the PDCCH and PDSCH described above, included in the upper control signals demodulated in the downlink shared data modulation section 108.

The downlink shared data modulation section 108 acquires user data and upper control information based on downlink shared data channel control information input from the downlink shared data channel control information demodulation section 107. The upper control information (including mode information) is output to the channel estimation section 110. The downlink shared channel data demodulation section 109 demodulates downlink shared channel data based on uplink shared data channel control information input from the uplink shared data channel control information demodulation section 106.

The channel estimation section 110 performs channel estimation using common RSs. Also, in fallback mode, the channel estimation section 110 performs channel estimation for fallback mode based on mode information. That is to say, channel estimation is switched between multiple-stream transmission mode and fallback mode. To be more specific, in multiple-stream transmission mode, the channel estimation section 110 performs channel estimation based on the special subframe reference signal structure illustrated in FIG. 2, and, in fallback mode, channel estimation section 110 performs channel estimation based on the reference signal structure illustrated in FIG. 3(a) or FIG. 3(b).

Also, the channel estimation section 110 outputs the estimated channel variation to the shared control channel control information demodulation section 105, uplink shared data channel control information demodulation section 106, downlink shared data channel control information demodulation section 107 and downlink shared data modulation section 108. These demodulation sections demodulate downlink signals using the estimated channel variation and demodulation reference signals.

Next, the uplink configuration of the mobile terminal apparatus 10 will be described. The data generation section 111 generates uplink user data. The channel coding section 112 performs channel coding of user data output from the data generation section 111. The modulation section 113 modulates the transmission data having been subjected to channel coding in the channel coding section 112. The DFT section 114 converts the modulated transmission data from a time sequence signal into a frequency domain signal by performing a discrete Fourier transform (DFT: Discrete Fourier Transform), and inputs the frequency domain signal in the mapping sections 115. The mapping sections 115 maps the transmission data to radio resources based on assignment information reported on the downlink. The IFFT section 116 performs an inverse fast Fourier transform on the transmission data and converts the frequency domain signal into a time domain signal. The CP insertion section 117 insets CPs in the time domain signal of transmission data. The transmission data in which CPs have been inserted is transmitted to the transmission/reception section 13.

As described above, with the radio communication method according to the present embodiment, a radio base station apparatus, in fall back mode, performs scheduling for fallback mode, which takes into account the reference signal structures in fallback mode, and transmits transmission signal after the scheduling by open loop control transmission diversity, and a mobile terminal apparatus receives a downlink signal including mode information, and, in the above-described fallback mode, performs channel estimation for fallback mode based on the mode information, and demodulates the downlink signal using the acquired channel estimation value.

With the present embodiment, in fallback mode, scheduling for fallback mode, which takes into account the reference signal structures for fallback mode, is performed, so that, when transmission diversity is applied to fallback mode in the LTE-A system, it is possible to realize highly efficient fallback mode.

The present invention is by no means limited to the above embodiments and can be implemented in various modifications. The number of layers and reference signal structures in the above embodiments are only examples, and are by no means limiting. Also, without departing from the spirit of the present invention, it is possible to change the number of processing parts and the steps of processing in the above description as appropriate. Parts illustrated in the drawings each have functions, and each function block may be implemented by hardware or may be implemented by software. Addition modifications are also possible as appropriate without departing from the spirit of the present invention. Other changes are also possible as appropriate without departing from the spirit of the present invention.

### INDUSTRIAL APPLICABILITY

The present invention is effective for use for a mobile terminal apparatus, radio base station apparatus and transmission power control method in an LTE-A system.

The disclosure of Japanese Patent Application No. 2010-008139, filed on Jan. 18, 2010, including the specification, drawings, and abstract, is incorporated herein by reference in its entirety.

1. A radio base station apparatus comprising:
a precoding section configured to perform precoding for transmission data including a demodulation reference signal;
a multiplexing section configured to multiplex a common reference signal and the transmission data after the precoding; and
a transmission section configured to transmit a transmission signal after the multiplexing,
wherein, in fallback mode, the precoding section changes a precoding matrix per resource block of the transmission data.

2. A radio base station apparatus comprising:
a scheduling section configured to, in fallback mode, perform scheduling for fallback mode, which takes into account a reference signal structure in fallback mode; and
a transmission section configured to transmit the scheduled transmission signal by transmission diversity with open loop control.

3. The radio base station apparatus as defined in claim 2, wherein the reference signal structure is a structure of placement of common reference signals in an LTE system.

4. The radio base station apparatus as defined in claim 2, wherein the reference signal structure is a structure in which, in a special subframe structure in an LTE-A system, the common reference signal is placed instead of the demodulation reference signal.

5. A mobile terminal apparatus comprising:
a reception section configured to receive a downlink signal including mode information;
a channel estimation section configured to, in fallback mode, perform channel estimation for fallback mode based on the mode information; and
a demodulation section configured to demodulate the downlink signal using a channel estimation value determined in the channel estimation section.

6. The mobile terminal apparatus as defined in claim 5, wherein the reference signal structure is a structure of placement of common reference signals in an LTE system.

7. The mobile terminal apparatus as defined in claim 5, wherein the reference signal structure is a structure in which, in a special subframe structure in an LTE-A system, the common reference signal is placed instead of the demodulation reference signal.

8. A radio communication method comprising the steps of:
in a radio base station apparatus:
performing precoding for transmission data including a demodulation reference signal;
multiplexing a common reference signal and the transmission data after the precoding; and
transmitting a transmission signal after the multiplexing,
wherein, in fallback mode, a precoding matrix is changed per resource block of the transmission data.

9. A radio communication method comprising the steps of:
in a radio base station apparatus:
in fallback mode, performing scheduling for fallback mode, which takes into account a reference signal structure in fallback mode; and
transmitting the transmission signal after the scheduling by transmission diversity with open loop control; and
in a mobile terminal apparatus:
receiving a downlink signal including mode information; in fallback mode, performing channel estimation for fallback mode based on the mode information; and
demodulating the downlink signal using a determined channel estimation value.
